(19) United States
(12) Patent Application Publication
(10) Pub. No.: US 2020/0285719 A1
(43) Pub. Date: Sep. 10, 2020

(54) OBFUSCATED SHIFT REGISTERS FOR INTEGRATED CIRCUITS

(71) Applicant: INSIDE SECURE, Meyreuil (FR)

(72) Inventors: Bryan J. Wang, South Lake Tahoe, CA (US); Lap Wai Chow, S. Pasadena, CA (US); James P. Baukus, Westlake Village, CA (US); Ronald P. Cocchi, Seal Beach, CA (US)

(73) Assignee: INSIDE SECURE, Meyreuil (FR)

(21) Appl. No.: 16/297,511

(22) Filed: Mar. 8, 2019

(51) Int. Cl. G06F 21/14; H03K 19/20; G01R 31/3185; G11C 7/10

(52) U.S. Cl. CPC G06F 21/14; G11C 7/1051; G01R 31/318525; H03K 19/20

(57) ABSTRACT

A camouflaged shift registers and method for producing same is disclosed. In one embodiment, the camouflaged shift register comprises a plurality of serially coupled flip-flops, each of the flip-flops comprising a logic output communicatively coupled to an input of a serially adjacent next flip-flop and a camouflage element communicatively coupled between the logic output of a first flip-flop of the plurality of flip-flops and the input of a second flip-flop of the plurality of flip-flops serially adjacent to the first flip-flop, wherein the camouflage element has a physical layout mimicking a first function but performs a second function different from the first function.

### BACKGROUND

### 1. Field

The present disclosure relates to systems and methods for processing data, and in particular to a system and method for camouflaging shift registers.

### 2. Description of the Related Art

Integrated Circuit (IC) designs are vulnerable to IP theft from reverse engineering, unauthorized cloning and over-production, and device corruption due to Trojan insertion. The risks to the IC industry have been steadily increasing as reverse engineering capabilities increase, and as worldwide IC production capabilities consolidate into a small number of entities.

A shift register is a cascade of flip-flops (FFs) sharing the same clock wherein the output of each flip-flop is connected to the input of the next FF in the chain. A scan chain is a design technique utilizing shift registers, and is widely used in design for testing (DFT) of an integrated circuit (IC). Scan chains are an industry standard for IC hardware manufacturing testing. Scan chains allow for a high degree of fault detection by providing the tester with a high level of controllability and observability of internal nodes within the IC. But these same scan chains assist an adversary in attacking or reverse engineering an IC by providing a convenient mechanism to observe and control internal nodes. What is needed are methods to secure IC shift registers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. To address the requirements described above, this document discloses camouflaged shift registers and a system and methods for producing and using them.

One embodiment is evidenced by camouflaged sequential circuit such as a shift register or scan chain that comprises a plurality of serially coupled flip-flops, each of the flip-flops comprising a logic output communicatively coupled to an input of a serially adjacent next flip-flop and a camouflage element communicatively coupled between the logic output of a first flip-flop of the plurality of flip-flops and the input of a second flip-flop of the plurality of flip-flops serially adjacent to the first flip-flop. The camouflage element has a physical layout mimicking a first function but performs a second function different from the first function. Another embodiment is evidenced by a method of producing a camouflaged sequential circuit such as a shift register or scan chain, comprising interconnecting a plurality of serially coupled flip-flops, each of the flip-flops comprising a logic output communicatively coupled to an input of a serially adjacent next flip-flop and inserting a camouflage element communicatively coupled between the logic output of a first flip-flop of the plurality of flip-flops and the input of a second flip-flop of the plurality of flip-flops serially adjacent to the first flip-flop. Again, the camouflage element has a physical layout having first function but performs a second function different from the first function. A still further embodiment is evidence by a camouflaged shift register produced by the foregoing steps.

This disclosure methods presents techniques to secure IC shift registers using circuit camouflage hardware obfuscation technology. Scan chains utilizing obfuscated shift registers function differently than their layout suggests, which greatly complicates an attack of an IC using its scan chains.

### BRIEF DESCRIPTION OF THE DRAWINGS

Referring now to the drawings in which like reference numbers represent corresponding parts throughout.

FIG. 1 is a block diagram of a shift register;

FIGS. 2A and 2B are diagrams of an embodiment of a multiplexed flip-flop;

FIG. 3 is a diagram of a scan chain and communicatively coupled combinational logic;

FIGS. 4A and 4B are diagrams illustrating one embodiment of at least a portion of a shift register camouflaged by use of inverting and non-inverting elements having substantially similar physical layouts;

FIGS. 5A and 5B are diagrams illustrating another example of the use of camouflaged inverting and noninverting elements having substantially similar physical layouts;

FIGS. 6A and 6B are diagram depicting an embodiment of a shift register containing a camouflaged inverting flip-flop element;

FIGS. 7A and 7B are diagrams depicting an embodiment of a scan chain containing a camouflaged inverting multiplexed flip-flop (MFF) element;

FIGS. 8A and 8B are diagrams depicting an embodiment of a scan chain containing a camouflaged inverting MFF element;

FIGS. 9A-9C are diagrams illustrating embodiments of a shift register having camouflaged non-sequential elements;

FIGS. 10A-10C are diagrams illustrating embodiments of a scan chain having camouflaged non-sequential elements;

FIGS. 11A and 11B are a diagram illustrating a logic diagram of a camouflaged semi-sequential element;

FIG. 12 is a diagram illustrating an embodiment of a scan-chain that includes at least one camouflaged semi-sequential element;

FIGS. 13A and 13B is a diagram illustrating the use of camouflaged logic gates to employ apparent scan chain divergence and convergence to camouflage the circuit;

FIG. 14 is a diagram illustrating a scan chain containing apparent chain feedback from a subsequent scan chain element;

FIG. 15 is a diagram illustrating a scan chain containing apparent chain feedforward from a previous scan chain element;

FIG. 16 is a diagram illustrating exemplary operations that can be performed to produce a camouflaged shift register as described herein;

FIG. 17 is a diagram illustrating an exemplary computer system that can be used to implement the circuit designs presented herein.

### DESCRIPTION

In the following description, reference is made to the accompanying drawings which form a part hereof, and which is shown, by way of illustration, several embodiments. It is understood that other embodiments may be utilized, and structural changes may be made without departing from the scope of the present disclosure. In this disclosure and drawings, functionally similar items may be distinguished by an alphabetic suffix (e.g. items 100A. 100B, and 100C). In such cases, these items may be alternatively collectively referred to without the suffix (e.g. item(s) 100).

### Overview

### Circuit Camouflage Technology

Circuit camouflage technology is a type of hardware obfuscation that encompasses the design and use of camouflaged logic gates whose logical function is difficult to determine using conventional reverse engineering techniques. Selected embodiments discussed below utilize a style of camouflaged gate whose apparent physical design mimics that of a conventional logic gate of the standard cell library used to design the integrated circuit, but the camouflaged gate's actual logic function differs from that of the conventional logic gate that it mimics. This is the most prevalent type of camouflaged gate in use today. The camouflaged circuit contains a number of camouflaged gates among a sea of normal gates, and a netlist extracted with conventional reverse engineering techniques will contain a number of discrepancies proportional to the number of camouflaged gates used in the circuit. The number and location of the camouflaged gates is not apparent to the reverse engineer.

### Shift Register

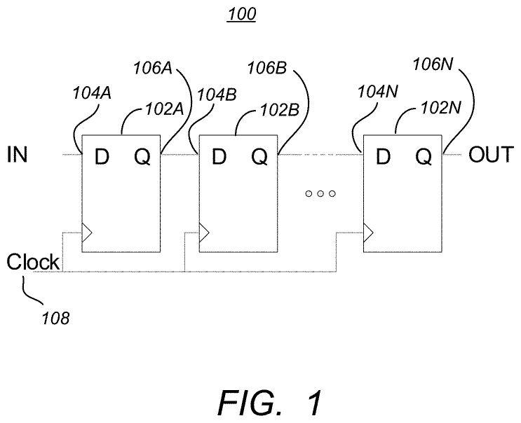

FIG. 1 is a block diagram of a shift register 100. The shift register 100 is a type of sequential circuit and comprises a plurality of serially coupled flip-flops 102A-102N (herein alternatively referred to as flip-flop(s) 102), each of the flip-flops 102A-102N comprising a logic input (104A-104N, respectively) and a logic output (106A-106N respectively). All but the last of the logic outputs 106A-106N are communicatively coupled to an input 104B-104N of a serially adjacent next flip-flop 102. In the illustrated embodiment, each flip-flop 102 is a delay (D) flip-flop 102.

A shift register 100 is a cascade of flip-flops (hereinafter alternatively referred to as FFs 102) sharing the same clock 108 wherein the output of each flip-flop 102 is connected to the input of the next flip-flop 102 in the chain of flip-flops. Shift registers may be used for arithmetic operations, serial I/O, and many other applications.

### Scan Chain

A scan chain is a technique used in the design of an Application Specific Integrated Circuit (ASIC) to improve testability by providing a way to set and observe FFs 102. It is an efficient way to apply patterns to FFs 102 during manufacturing test, and to allow the tester to observe the internal state of the circuit. Scan chains are comprised of a plurality of multiplexed flip-flops, which are further described below.

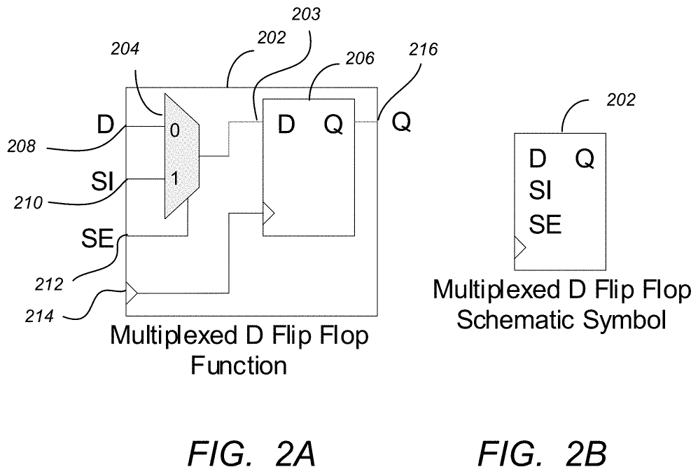

FIGS. 2A and 2B are diagrams of an embodiment of a multiplexed flip-flop (MFF) 202. FIG. 2A depicts a functional logic diagram of the MFF 202, while FIG. 2B depicts a schematic symbol for an MFF 202 as used in this disclosure. MFFs 202 are also known as scan flip-flops.

The MFF 202 includes a multiplexer 204 having an output communicatively coupled to an input 203 of a flip-flop 206. The MFF 202 includes a functional input (D) 208 communicatively coupled to a first multiplexer input and a scan input (SI) 210 communicatively coupled to a second multiplexer input. Selection of whether the functional input 208 or the scan input 210 is provided to the input 203 of the flip-flop 206 is controlled by a scan enable (SE) input 212 that is provided to the multiplexer 204. Clock input 214 is provided to a clock input of the flip-flop 206, and the output of the flip-flop 206 is provided as an output Q of the MFF 202. In the illustrated embodiment, the flip-flop 206 included within the MFF 202 is a delay flip-flop, but other flip-flop types can be used as well (e.g. SR flip-flops. JK flip-flops, T flip-flops).

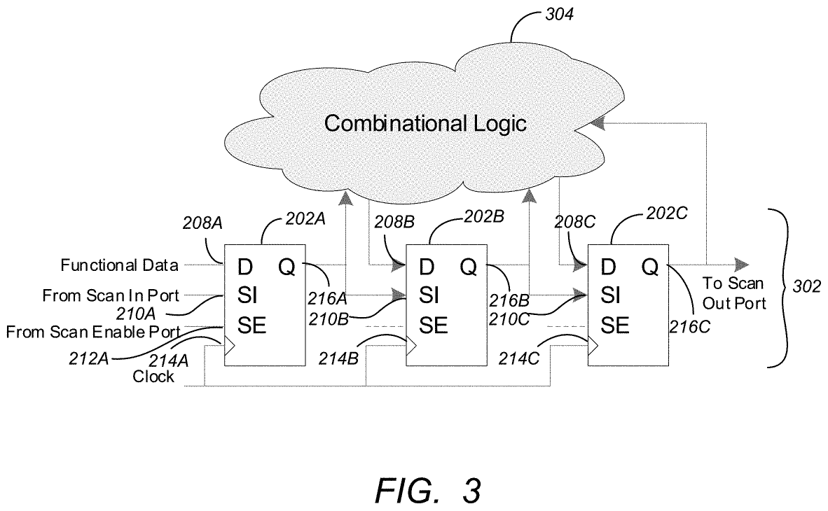

FIG. 3 is a diagram of a scan chain 302 and communicatively coupled combinational logic 304 The scan chain 302 is another type of sequential circuit and comprises a plurality serially coupled MFFs 202A-202C (hereinafter alternatively referred to as MFF(s) 202), each with an associated functional input (D) 208A-208C (hereinafter alternatively referred to as functional input(s) 208), an associated scan input (SI) 210A-210C (hereinafter alternatively referred to as scan input(s) 210), an associated scan enable (SE) input 212A-212C (hereinafter alternatively referred to as scan enable input(s) 212), and an output (Q) 216A-216C (hereinafter alternatively referred to as output(s) 216).

At least a portion of the functional (D) inputs 208 are communicatively coupled to combinational logic 304, as are at least a portion of the outputs (Q) 216. In the illustrated embodiment, functional inputs 208B and 208C are communicatively coupled to the combinational logic 304, as are outputs 216A, 216B, and 216C. QN (inverse) outputs may also be present in MFFs 202, and they may be communicatively coupled to combinational logic 304, to the next scan input 210 in the chain, or they may be floating.

The scan inputs 210 of the MFFs 202 are connected serially, with the logic output of each MFF 202 communicatively coupled to a functional input 208 of the serially adjacent next MFF 202. This enables shifting of scan data along the scan input 210A when the scan enable signal presented at the scan enable inputs 212 are active.

The scan chain 302, operating with the combinational logic 304, performs ASIC-specified functions when the scan mode is inactive (no signal provided to the scan enable (SE) inputs 212) and operates as a shift register when in the scan mode is active (signal provided to scan enable (SE) inputs 212). An integrated circuit may utilize multiple scan chains 302 that operate in parallel to reduce the amount of time required to load and observe scan patters. Test patterns may be generated automatically for scan-enabled circuitry.

### Security Issues Related to Scan Chains

The features that make scan chains 302 highly desirable for manufacturing test, namely the high level of controllability and observability of the internal state of the circuit, also raise security concerns. By shifting out the device's state through the scan chains 302, attackers may extract secrets such as cryptographic keys. Or by applying targeted test patterns, attackers may use the scan chains to assist in reverse-engineering the function of an integrated circuit.

Several methods exist to protect scan chains 302 from unauthorized use. Use of the scan mode may be protected by a hardware lock, requiring a secret key. This method preserves the scan chain 302 function, allowing for legitimate uses after manufacturing test, such as in-field debugging of the device. This method may be defeated if the attacker learns the secret key through one of any number of methods. A more secure method is to protect the scan chains by physically blowing a fuse once the device has undergone manufacturing test, thereby permanently disabling the scan chains. But even this protective method can be defeated by a focused ion beam, enabling an attacker to reconnect disabled scan chains.

### Circuit Camouflage Technology

Circuit camouflage technology encompasses the design and use of camouflaged logic gates whose logical function is difficult to determine using conventional reverse engineering techniques. The text and diagrams presented herein utilize a type of camouflaged gate having physical design or layout closely resembles that of a conventional logic gate of the standard cell library used to design the integrated circuit, but the camouflaged gate's actual logic function differs from that of the mimicked logic gates. The camouflaged circuit contains a number of camouflaged elements among a large number of normal elements, and a netlist extracted with conventional reverse engineering techniques will contain a number of discrepancies proportional to the number of camouflaged gates used in the circuit. The quantity and location of the camouflaged gates are not apparent to the attacker and are difficult to determine.

### Obfuscated Shift Registers

This specification discloses a number of techniques used to obfuscate shift registers, including shift registers used in scan chains. Each of the disclosed methods increases the workload and uncertainty presented to an attacker attempting to divine the function of an integrated circuit by typical reverse engineering techniques. While each technique is disclosed separately, the methods may be used in concert or independently. All camouflaged functions must be correctly identified and resolved before an attacker may utilize the shift registers.

In the illustrated and described embodiments, the shift registers or scan chains have a plurality of serially coupled flip-flops, each comprising a logic output communicatively coupled to an input of a serially adjacent next flip-flop. The shift registers or scan chains also comprise a camouflage element, communicatively coupled between the logic output of a first flip-flop of the plurality of flip-flops and the input of a second flip-flop of the plurality of flop flops serially adjacent the first flop. The camouflage element has a physical layout mimicking a first function, but performs a second function different from the first function. Embodiments are described below in which the camouflage element and mimicked functions differ, and in which the interconnection among the flip-flops and the camouflage elements vary.

### Complexities of Obfuscating Scan Chains

One of the problems associated with the use of scan chains for testing of circuits is that it cannot seriously compromise fault coverage or automated test pattern generation, and must meet testing metrics of combinational and sequential controllability and observability to assure that all relevant states are tested. However, attackers can use the a high degree of controllability and observability introduced by a scan chain upon the internal state of an IC, to analyze security countermeasures.

To protect scan chain designs while meeting these requirements, the prior art teaches several different techniques, including. (1) disabling scan chains by for example blowing fuses, (2) scan chain scrambling techniques to obfuscate register-to-scan chain mapping and make data interpretation more difficult, (3) disabling access to secret keys in the scan mode using a muxed-in mirror key register when the scan mode is enabled, but preventing access to cryptographic key registers, or the inclusion of dummy flip flops in the scan chain, and (4) using embedded structures to produce physically unclonable functions as a source of entropy.

It is important that security countermeasures that involve modifying scan chains be designed in such a way so as to not leak design information to an attacker. Additionally, a scan chain must exhibit a standard structure in order to be used in IC testing. Designers who apply security countermeasures in the scan chain structure must be careful to avoid introducing irregularities into the structure of the scan chain itself. The scan chain must also be compatible with automated test pattern generation (ATPG) software, with fault simulation and fault grading software, and with test hardware on the IC fabrication lines. Previous techniques attempt to preserve scan chain structure by disabling access or by scrambling elements or results peripheral to the scan chain structure, rather than obfuscating, on a device level, the scan chain structure itself.

The techniques disclosed in this document are able to offer protection against reverse engineering while maintaining a functioning scan chain structure, and without leaking design information that can lead to the successful reverse-engineering of the device. Further, while the camouflaging of a pure combinatorial logic circuit essentially obscures the true function of that logic circuit itself, the true function may ultimately be ascertained by examination of logical input and output combinations. The introduction of sequential elements complicates the assessment of the logical function, but with scan inputs, inherently provides more states and greater insight as to the actual functioning of the circuit elements. Accordingly, the camouflage of the sequential elements provides proportionally greater security improvement to the circuits that include them than the security improvements offered by the use of camouflage elements in purely combinational logic.

### Camouflaged Inverting or Non-Inverting Elements

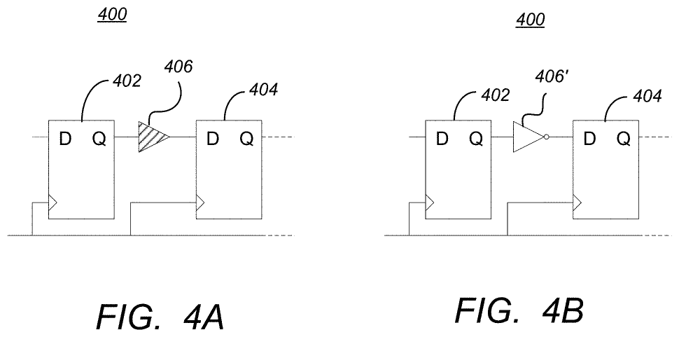

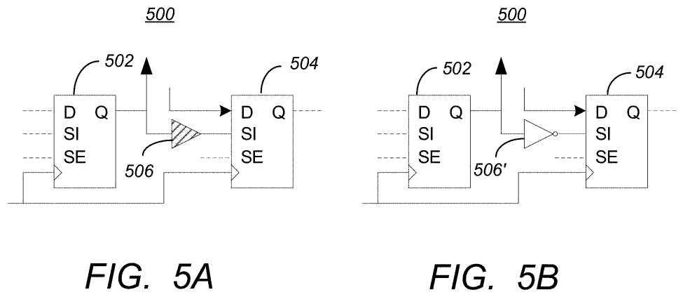

One technique of hindering reverse engineering of circuit designs is through the use elements which fool the reverse engineer into believing an inverter has a non-inverting function or that a buffer or other non-inverting element is performing an inversion function. Several embodiments of the use of camouflage technology using this technique are presented below. In this embodiment, the camouflage element comprises a logic cell, and one of the first function and the second function is a buffer or non-inverting function, and the other function is an inversion function. This is illustrated in FIGS. 4A-4B and 5A-5B below.

FIGS. 4A and 4B are diagrams illustrating one embodiment of at least a portion of a shift register 400 camouflaged by use of inverting and non-inverting elements having substantially similar physical layouts. FIG. 4A is a logic diagram illustrating the apparent function of the shift register 400 as it is divined from the physical layout of the circuit elements on an integrated circuit. FIG. 4B is a logic diagram showing the actual function of the shift register 400 as it is implemented. In both FIGS. 4A and 4B, the shift register 400 comprises a first flip-flop 402 having an output communicatively coupled to an input of a serially adjacent next flip-flop 404. A camouflage element 406 is communicatively coupled between the logic output of the first flip-flop 402 and the input of a serially adjacent next flip-flop 404. In the illustrated embodiment, the camouflage element is a logic cell that has a physical layout mimicking a buffer function (illustrated by shaded logic cell 406 of FIG. 4A), but in fact, performs an inversion function (indicated by inverter 406′ of FIG. 4B).

FIGS. 5A and 5B are diagrams illustrating another example of the use of camouflaged inverting and noninverting elements having substantially similar physical layouts. FIG. 5A is a logic diagram illustrating the apparent function of the scan chain 500 as it is divined from the physical layout of the circuit elements on an integrated circuit. FIG. 5B is a logic diagram showing the actual function of the shift register 400 as it is implemented. In both FIGS. 5A and 5B, the scan chain 500 comprises a first MFF 502 having an output communicatively coupled to a scan input (SI) of a serially adjacent next MFF 504. Further, a camouflage element 506 is communicatively coupled between the logic output of the first MFF 502 and the input of a serially adjacent next MFF 504. In the illustrated embodiment, the camouflage element is a logic cell 506 that has a physical layout mimicking a buffer function (illustrated by shaded logic cell 506 of FIG. 5A), but in fact, performs an inversion function (indicated by inverter 506′ of FIG. 5B).

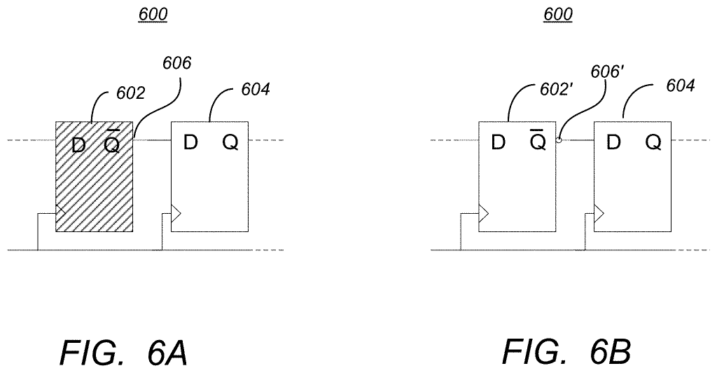

Camouflaged inversions may also be incorporated into the flip-flop devices themselves. In such embodiments, the camouflage element comprises the logic output of the first flip-flop or the logic input of the second flip-flop. The camouflage element function may appear to be a non-inversion function and in fact be inversion function or may appear to be an inversion function and in fact be a non-inversion function. For example, FIGS. 6A and 6B are diagram depicting an embodiment of a shift register 600 containing a camouflaged inverting flip-flop element. FIG. 6A is a logic diagram illustrating the apparent function of the shift register 600 as it is divined from the physical layout of the circuit elements on an integrated circuit. FIG. 6B is a logic diagram showing the actual function of the shift register 600 as it is implemented. In both FIGS. 6A and 6B, the shift register 600 comprises a first flip-flop 602 having an output communicatively coupled to an input of a serially adjacent next flip-flop 604. In this embodiment, the camouflage element is the logic output 606 of the first flip-flop 602. The physical layout of logic output 606 the first flip-flop 602 mimics a non-inverting output (illustrated by shaded flip-flop 602) but in fact, is an inverting output (indicated by 606′).

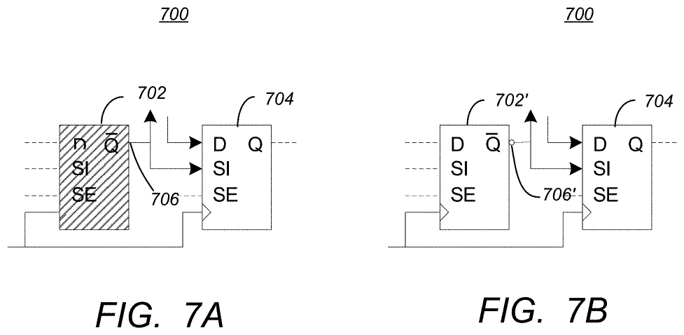

Similarly, FIGS. 7A and 7B are diagrams depicting an embodiment of a scan chain 700 containing a camouflaged inverting MFF element. FIG. 7A is a logic diagram illustrating the apparent function of the scan chain 700 as it is divined from the physical layout of the circuit elements on an integrated circuit. FIG. 7B is a logic diagram showing the actual function of the scan chain 700 as it is implemented. In both FIG. 7A and FIG. 7B, the scan chain 700 comprises a first MFF 702 having an output 706 communicatively coupled to a scan input (SI) of a serially adjacent next MFF 704. The camouflage element is the logic output 706 of the first MFF 702 having a physical layout that mimics a non-inverting output 706 but in fact, is an inverting output (indicated by 706′).

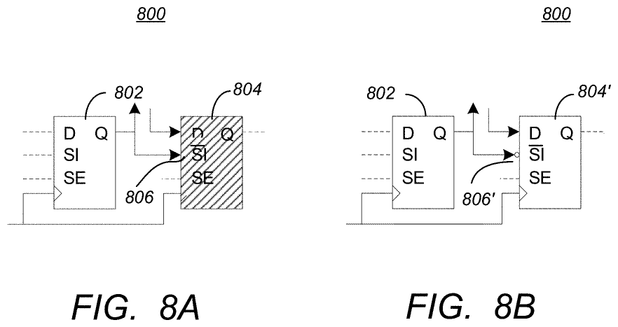

FIGS. 8A and 8B are diagrams depicting an embodiment of a scan chain 800 containing a camouflaged inverting MFF element. FIG. 8A is a logic diagram illustrating the apparent function of the scan chain 800 as it is divined from the physical layout of the circuit elements on an integrated circuit. FIG. 8B is a logic diagram showing the actual function of the scan chain 800 as it is implemented. In both FIGS. 8A and 8B, the scan chain 800 comprises a first MFF 802 having an output communicatively coupled to a scan input (SI) 806 of a serially adjacent next MFF 804. The camouflage element is the logic input 806 of the second MFF 804 having a physical layout that mimics active-high input 806 but in fact, is an active-low input 806′.

Paths between shift register or scan chain elements may also be camouflaged by configuring them to appear to be inverting when they are in fact non-inverting. This can be implemented as described above, except by substituting camouflaged devices that appear to invert but in fact do not invert. CMOS logic gates are typically designed such that an inverting device is physically smaller than a non-inverting device. Hence, embodiments in which the camouflaged devices appear to invert but in fact do not are less desirable.

The camouflaged inverting and non-inverting features are known to the designer of the integrated circuit, who can account for them in the circuit function and manufacturing test patterns. However, an attacker will need to correctly identify all camouflaged inverting and non-inverting features in the circuit in order to utilize the camouflaged shift registers or scan chains.

Using an even number of camouflaged inverting or non-inverting elements in a given scan chain is a particularly useful case in scan chain obfuscation. The scan chain's observable output at the scan out port will match its expected value, and an adversary would not be alerted to the fact that camouflaged elements in the scan chain are corrupting attempts to analyze the device. Camouflaged inverting or non-inverting elements will alter the state of the scan chain with respect to its expected values, but this fact would not be observable at the scan chain's primary output.

### Camouflaged Non-Sequential Element

Another technique of hindering reverse engineering of circuit designs is through the use elements that mimic a sequential element such as a flip-flop, but in fact perform non-sequential function such as buffering, inversion, or non-sequentially combining logical inputs. With this technique, one of the first function and the second function is that of a delay flip-flop and the other of the first function and the second function is one of a combinational logic cell, a buffer between the logic output of a preceding flip-flop and the succeeding flip-flop, an inverting buffer between the logic output of the preceding flip-flop and the succeeding flip-flop, and a multiplexer. Such embodiments of the use of camouflage technology using this technique are presented below.

A camouflaged non-sequential element has a physical layout mimicking a normal sequential element (and so appears to be a normal sequential element to the reverse engineer) but in fact is a combinational element such as an inverter. Camouflaged non-sequential elements lead to a discrepancy between the apparent and actual number of flip-flops in a shift register or a scan chain, thus confusing reverse engineering attempts.

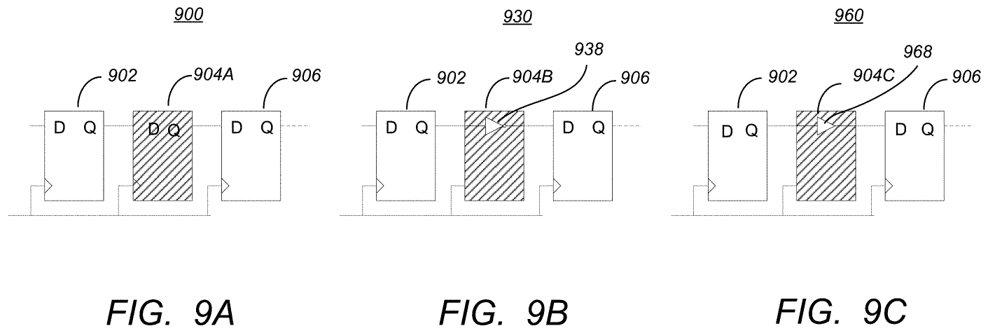

FIGS. 9A-9C are diagrams illustrating embodiments of a shift register 900 having camouflaged non-sequential elements.

FIG. 9A illustrates a logic diagram of a first embodiment of a camouflaged shift register 900. In this embodiment, the shift register 900 appears to comprise a first flip-flop 902 that has an output communicatively coupled to an input of a serially adjacent next flip-flop 904A and the output of this flip-flop 904A is provided to the next flip-flop 906 serially adjacent to flip-flop 904A. However, while flip-flops 902 and 906 are indeed flip-flops, what appears to be flip-flop 904A is in fact a combinational logic cell that has a physical layout that mimics the physical layout of a flip-flop.

FIG. 9B illustrates a logic diagram of a second embodiment of the camouflaged shift register 930. In this embodiment, the shift register 900 appears to comprise a first flip-flop 902 that has an output communicatively coupled to an input of a serially adjacent next flip-flop 904B and the output of this flip-flop 904B is provided to the next flip-flop 906 serially adjacent to flip-flop 904A. However, while flip-flops 902 and 906 are indeed flip-flops, what appears to be flip-flop 904B is in fact an inverting buffer cell 938 that has a physical layout that mimics the physical layout of a flip-flop.

FIG. 9C illustrates a logic diagram of a third embodiment of the shift register 960. In this embodiment, the shift register 900 appears to comprise a first flip-flop 902 that has an output communicatively coupled to an input of a serially adjacent next flip-flop 904C and the output of this flip-flop 904C is provided to the next flip-flop 906 serially adjacent to flip-flop 904A. However, while flip-flops 902 and 906 are indeed flip-flops, what appears to be flip-flop 904C is in fact a non-inverting buffer cell 968 that has a physical layout that mimics the physical layout of a flip-flop.

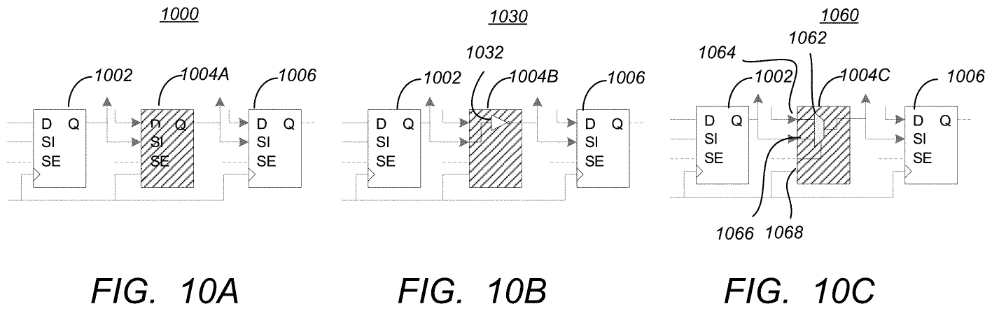

FIGS. 10A-10C are diagrams illustrating embodiments of a scan chain 1000 having camouflaged non-sequential elements.

FIG. 10A illustrates a logic diagram of a first embodiment of the scan chain 1000. In this embodiment, the shift register 1000 appears to comprise a first MFF 1002 that has an output communicatively coupled to a scan input (SI) of a serially adjacent next MFF 1004A and the output of this MFF 1004A is provided to the next MFF 1006 serially adjacent to MFF 1004A. However, while MFFs 1002 and 1006 are indeed MFFs, what appears to be an MFF 1004A is in fact a combinational logic cell that has a physical layout that mimics the physical layout of an MFF.

FIG. 10B illustrates a logic diagram of a second embodiment of a scan chain 1030. In this embodiment, the scan chain 1030 appears to comprise a first MFF 1002 that has an output communicatively coupled to a scan input (SI) of a serially adjacent next MFF 1004B and the output of this MFF 1004B is provided to the next MFF 1006 serially adjacent to MFF 1004B. However, while MFFs 1002 and 1006 are indeed MFFs, what appears to be an MFF 1004B is in fact an inverting buffer cell 1032 having an input coupled to the output of MFF 1002 and an output coupled to the input of MFF 1006 that has a physical layout that mimics the physical layout of an MFF.

FIG. 10C illustrates a logic diagram of a first embodiment of the scan chain 1060. In this embodiment, the scan chain 1060 appears comprise a first MFF 1002 that has an output communicatively coupled to a scan input (SI) of a serially adjacent next MFF 1004C and the output of this MFF 1004C is provided to the next MFF 1006 serially adjacent to MFF 1004C. However, while MFFs 1002 and 1006 are indeed MFFs, what appears to be an MFF 1004C is in fact a multiplexer 1062 having a first input 1064 coupled to the combinational logic 304 and second input 1066 coupled to the logic output of MFF 1002 via what appears to be a scan input (SI) of what appears to be MFF 1004C, and a select input 1068 coupled to what appears to be the scan enable (SE) input of the MFF 1004C.

The camouflaged non-sequential element may also be implemented as a camouflaged connection, similar to a wire. This is logically equivalent to a non-inverting buffer, but with different design considerations. As before, the camouflaged non-sequential elements are known to the IC designer, who can account for them in the circuit function and manufacturing test patterns. However, an attacker will need to correctly identify all camouflaged non-sequential elements in the circuit in order to utilize the camouflaged shift registers or scan chains.

### Camouflaged Semi-Sequential Element

A camouflaged semi-sequential element appears to be a normal multiplexed flip-flop element but in fact has both sequential and combinational outputs. The camouflaged semi-sequential element is designed, through camouflaged circuit design techniques, to resemble a multiplexed flip-flop.

These camouflaged semi-sequential elements can perform a variety of combinational logic functions, but the function of an inverter or a non-inverting buffer are especially practical for maintaining the structure of a scan chain.

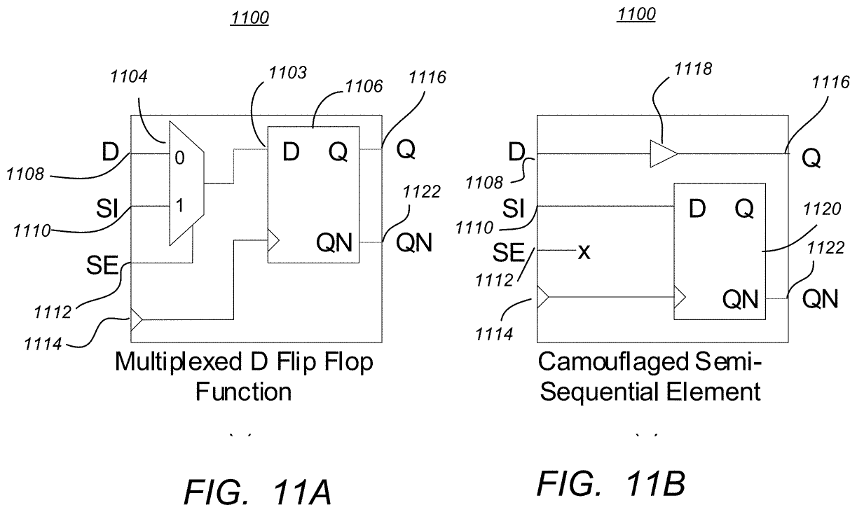

FIGS. 11A and 11B are a diagram illustrating a logic diagram of a camouflaged semi-sequential element. FIG. 11A depicts the apparent functionality of the camouflaged semi-sequential element (e.g. determined by the appearance of the layout of the transistors and other circuit elements that together comprise the camouflaged semi-sequential element), while FIG. 11B depicts the actual functionality of the camouflaged semi-sequential element 1100. The apparent functionality is as described with respect to the actualized MFF 202 shown in FIG. 2. Hence, the camouflaged semi-sequential element 1100 has the apparent functionality of elements including a multiplexer 1104 having an output communicatively coupled to an input 1103 of a flip-flop 1106. The camouflaged semi-sequential element 1100 also includes a functional input (D) 1108 communicatively coupled to a first multiplexer input and a scan input (SI) 1110 communicatively coupled to a second multiplexer input. Selection of whether the functional input 1108 or the scan input 1110 is provided to the input 1103 of the flip-flop 1106 is controlled by a scan enable (SE) input 1112 that is provided to the multiplexer 1104. Clock input 1114 is provided to a clock input of the flip-flop 1106, and the non-inverted output of the flip-flop 1106 is provided as an output Q 1116 of the camouflaged semi-sequential element 1100, while the inverted output is provided as the inverted output QN 1122.

FIG. 11B depicts the actual functionality of the camouflaged semi-sequential element 1100. As illustrated, the camouflaged semi-sequential element 1100 comprises a buffer 1118 communicatively coupled between the functional input (D) 1108 and the output Q 1116 of the camouflaged semi-sequential element 1100. Also, the scan input (SI) 1110 is communicatively coupled to the data input (D) of flip-flop 1120, and the clock input 1114 is coupled to a clock input of flip-flop 1120, while the scan enable (SE) input 1112 is left open and uncoupled to the output, and the inverted output of the flip-flop is presented as the inverted output QN 1122.

FIG. 11B illustrates a non-inverting combinational output 1116 and an inverting sequential output 1122. However, other embodiments are possible. For example, the combinational output Q may be a logical equivalent or logical inversion of the D input, any other combinational function of device inputs 1108, 1110 or 1112, or a static value (logic 0 or logic 1). Further, the sequential output QN of the clocked storage element 1120 of the camouflaged semi-sequential element 1100 can be either the inverting (QN) or non-inverting (Q) output of the clocked storage element 1120 that captures the ST input 1110.

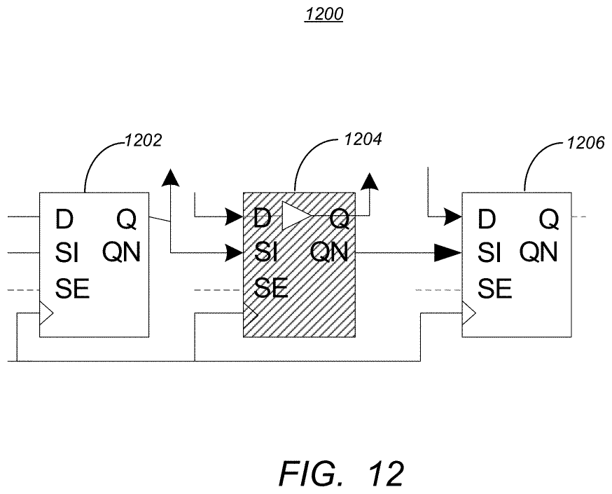

FIG. 12 is a diagram illustrating an embodiment of a scan-chain 1200 that includes at least one camouflaged semi-sequential element 1204. In this embodiment each input of the plurality of inputs of the scan chain 1200 comprises a scan input (SI), the plurality of flip-flops are multiplexed flip-flops, each having an associated one of the scan inputs (SI), a logic input (D), and an inverted output (QN). At least some of the logic inputs (D) of the plurality of flip-flops are communicatively coupled to the combinational logic (not shown). Further, one of the first function and the second function is that of an MFF and the other of the first function and the other of the first function and the second function is that of one or more of: (1) a non-inverting buffer between the logic output Q of the first flip-flop 1202 and the logic input D of the second MFF 1206, (2) an inverting buffer between the logic output Q of the first flip-flop 1202 and the logic input (D) of the second MFF 1206, and a sequential element 1120 coupled between the logic output Q of the first flip-flop 1202 and the scan input SI of the second flip-flop 1206.

Specifically, the scan chain 1200 appears to comprise three MFFs 1202-1206, coupled with the first MFF 1202 having a non-inverted output that is coupled to the combinational logic and to a scan input (SI) of the serially adjacent next MFF 1204. The input (D) of the serially adjacent next MFF 1204 is also communicatively coupled to the combinational logic, as is the non-inverted output of the serially adjacent next MFF 1204. The inverted output of the serially adjacent next MFF 1204 is coupled to the scan input (SI) of the next flip-flop 1206 serially adjacent to flip-flop 1204, while the input (D) is coupled to combinational logic.

However, although the second MFF 1204 appears to be a standard multiplexed D Flip-flop, it is in fact, a camouflaged semi-sequential element with the structure shown in FIG. 11B, and the Q output, which drives ASIC combinational core logic, behaves like a buffer instead of the output of a flip-flop. Further, the QN output of the camouflaged semi-sequential element 1204 behaves as a registered, inverted SI input, and this QN output is used to construct the scan chain 1200. The camouflaged semi-sequential element may also be implemented as a camouflaged connection, similar to a wire. This is logically equivalent to a non-inverting buffer, but with different design considerations.

Using camouflaged semi-sequential elements allows the IC designers to insert obfuscation to sequential elements while keeping the apparent and observable scan chain lengths equal. This is a particularly useful case in scan chain obfuscation. The scan chain's observable output at the scan out port will match its expected value, and an adversary would not be alerted to the fact that camouflaged elements in the scan chain are corrupting attempts to analyze the device. The camouflaged semi-sequential elements are known to the IC designer, who can account for them in the circuit function and manufacturing test patterns. However, an attacker will need to correctly identify all camouflaged semi-sequential elements in the circuit in order to utilize the camouflaged scan chains.

### Apparent Chain Divergence or Convergence

Normally, scan chains are each comprised of a single chain of elements that do not diverge or converge. Apparent scan chain divergence can introduce ambiguity into an attacker's circuit model by creating the appearance of scan chain divergence (a scan chain element leading to two or more subsequent scan chain elements) or convergence (two or more scan chain elements converging to the same single subsequent scan chain element). This will cause an attacker to spend resources analyzing what appears to be an anomaly in the circuit. The concept is the same when applying apparent chain divergence or convergence to shift registers.

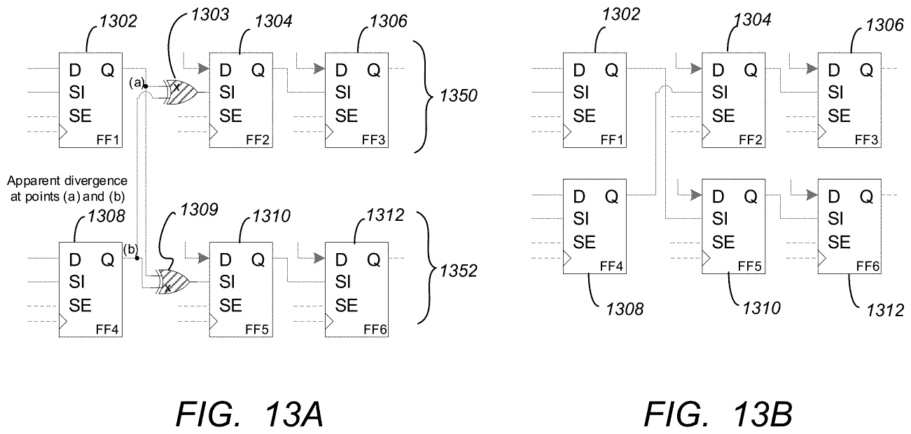

FIGS. 13A and 13B is a diagram illustrating the use of camouflaged logic gates to employ apparent scan chain divergence and convergence to camouflage the circuit. To simplify the diagrams, connections between the flip-flops' Q pin outputs and the IC's combinational logic cloud are omitted. FIG. 13A is a diagram showing the apparent function of the scan chains, while FIG. 13B is a diagram showing a functional schematic of the actual functionality of the scan chains.

In this embodiment, first MFF 1304, second MFF 1303 and third MFF 1306 are members of a first scan chain 1350, and a logic gate 1303 operates as a camouflage element. Further, MFF 1308, 1310, and 1312 are members of a second scan chain 1352, with logic cell 1309 operating as a camouflage element.

In this embodiment, the first function of the camouflage element 1303 is a logical function (e.g. XOR) of the logic output of first MFF 1302 in the first scan chain and the logical output of a flip-flop 1308 of a second scan chain 1352, and the second function is a logical function (e.g. non-inverting buffer) of only the logical output Q of the first flip-flop 1302.

Turning first to FIG. 13A, a logic gate 1303 is inserted between the Q output of MFF 1302 and SI input of MFF 1304. The logic gate 1303 has one input communicatively coupled to the Q output of MFF 1302 and another input communicatively coupled to the output of MFF 1308. Also, logic gate 1309 is inserted between the Q output of MFF 1308 and the SI input of MFF 1310. The logic gate 1309 has one input communicatively coupled to the Q output of MFF 1308 and another input communicatively coupled to the output of MFF 1302. In this configuration, points (a) and (b) on FIG. 13A represent points of apparent scan chain divergence, while logic gates 1303 and 1309 appear to provide convergence of scan chains 1350 and 1352.

However, although the logic gates 1303 and 1309 appear to function as XOR logic gates, they are in fact camouflaged gates that actually function as if one of their inputs are disabled. Thus, the actual functionality of the scan chains 1350 and 1352 is as illustrated in FIG. 13B. In the illustrated embodiment, logic gates 1303 and 1309 are XOR gates, but the same or analogous functionality may be employed with other logical cages (AND, NAND, OR) or combinations of such gates.

The camouflaged circuitry that creates apparent chain divergence and convergence is known to the IC designer, who can account for it in the circuit function and manufacturing test patterns. However, an attacker will need to correctly resolve all ambiguities in the obfuscated scan chains before being able to utilize them.

### Apparent Feedback and Feedforward

Apparent chain feedback and feedforward can introduce ambiguity into an attacker's circuit model by creating the appearance of feedback (in which an element's input is a combinational function of the prior element's output and one or more outputs of one or more subsequent elements) and feedforward (in which an element's input is a combinational function of an output of the preceding element and one or more outputs of one or more previous to the preceding element). Normally, the scan data paths of scan chains are each comprised of a single chain of elements that are connected serially, without feedback or feedforward connections and logic. The inclusion of apparent feedback and/or feedforward elements in the chain will cause an attacker to spend resources analyzing what appears to be an anomaly in the circuit.

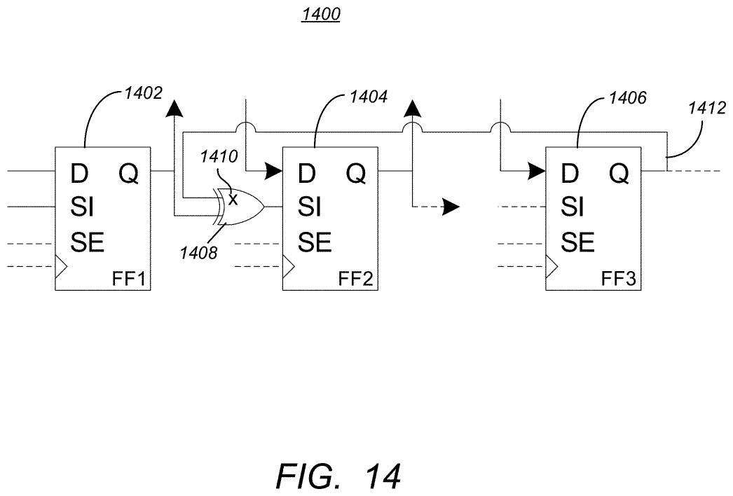

FIG. 14 is a diagram depicting an embodiment of a scan chain 1400 containing apparent chain feedback from a subsequent chain element. The illustrated scan chain 1400 includes serially coupled logic gates 1402-1406. The output Q of logic gate 1402 is communicatively coupled to the scan input SI of logic gate 1404 via a dual input exclusive OR (XOR2) gate 1408. Further, the output Q of logic gate 1404 is coupled to a scan input of logic gate 1406. The output Q 1412 of subsequent element in the scan chain (e.g. the output of logic gate 1406) is provided to communicatively coupled combinational logic and by appearances, to an input of an element previous to the subsequent element. Hence, the output Q of logic gate 1406 appears to propagate through combinational logic (e.g. XOR gate 1408) to the input of an earlier element in the scan chain (e.g. logic gate 1404). However, one or more camouflaged gates in the logic path prevent the output of the later element from affecting the input of the earlier element. Accordingly, the camouflage gate 1408 has a physical layout having a first function (e.g. a logical function of the logical output of the first flip-flop 1402 and the logical output of another flip-flop 1406) but in fact implements a second function (e.g. a logical function of only the output of first flip-flop 1402).

In the illustrated example, an XOR2 gate 1408 is used to present the appearance of an apparent feedback function, but since the input pin 1410 of XOR2 gate 1408 is camouflaged to appear to be functional but is in fact disabled, the feedback function is not actually implemented by the circuit. Hence, a camouflaged gate 1408 in the feedback logic path prevents the signal from altering the function of the circuit by providing feedback from subsequent elements in the scan chain 1400.

Other embodiments may incorporate other types or combinations of camouflaged and non-camouflaged gates.

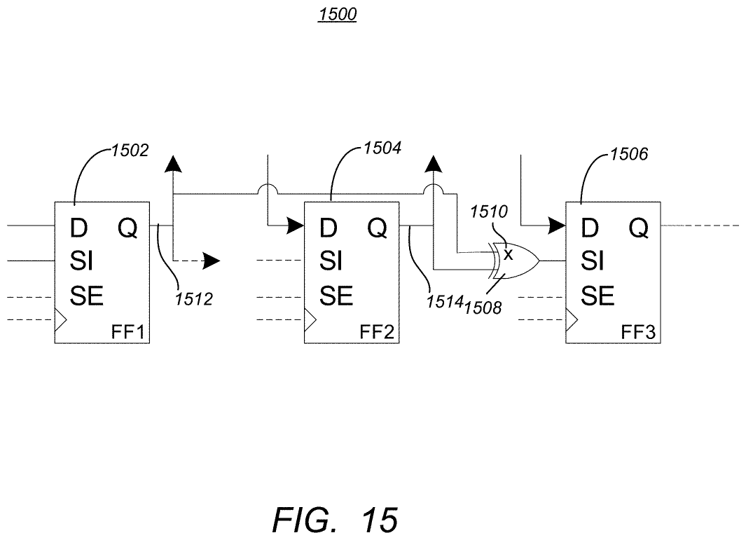

FIG. 15 is a diagram illustrating an embodiment of a scan chain 1500 containing an apparent chain feedforward function from a previous chain element. The illustrated scan chain 1500 comprises serially coupled logic gates 1502-1506. The output Q 1512 of logic gate 1502 is communicatively coupled to the scan input SI of logic gate 1504, and the output Q 1514 of logic gate 1504 is communicatively coupled to the scan input SI of logic gate 1506 via an input of a dual input exclusive OR (XOR2) gate 1508. Further, the output Q of logic gate 1502 is coupled to the scan input ST of logic gate 1506 via another input of the XOR2 gate 1508. Accordingly, the output of an earlier element (e.g. logic gate 1502) in the scan chain 1500 appears to propagate through combinational logic (e.g. XOR2 gate 1508) to the input of a later element (e.g. logic gate 1506). However, one or more camouflaged gates in the logic path prevent the output of the earlier element from affecting the input of the later element (in the illustrated embodiment, XOR2 gate 1508 is camouflaged to appear to have normal functionality, but input pin 1510 is in fact disabled). This example uses an XOR2 gate with a disabled input pin. Other embodiments may incorporate other types of camouflaged and non-camouflaged gates.

The apparent feedback and feedforward techniques described above using scan chains are similarly applicable to shift register embodiments. Feedback and feedforward are commonly used in designs that utilize shift registers, so their presence in this case will not be anomalous. The presence of camouflage elements that implement apparent feedback or feedforward connections in the shift register introduce discrepancies between the circuit's apparent function and its actual function.

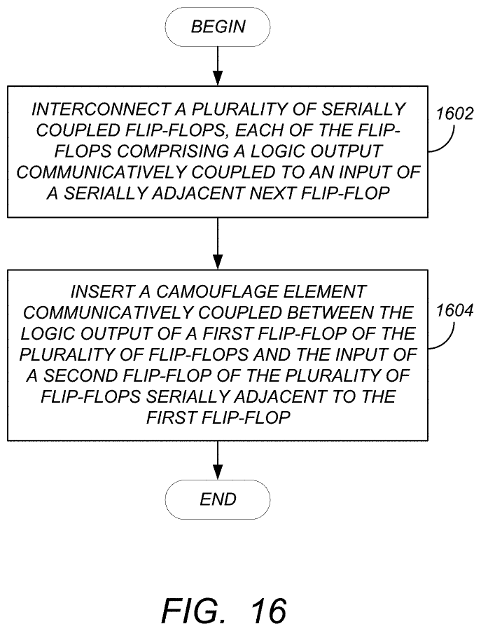

FIG. 16 is a diagram illustrating exemplary operations that can be performed to produce a camouflaged shift register as described above. These stops may be performed manually or with a computer programmed to layout a circuit design on an integrated circuit such as an ASIC using a cell library.

In block 1602, a plurality of flip-flops are interconnected so as to be serially coupled. Each of the flip-flops comprises a logic output communicatively coupled to an input of a serially adjacent next flip-flop. In block 1604, a camouflage element is communicatively coupled between the logic output of the first flip-flop and the input of a second flip-flop or the plurality of flip-flops serially adjacent to the first flip-flop.

### Hardware Environment

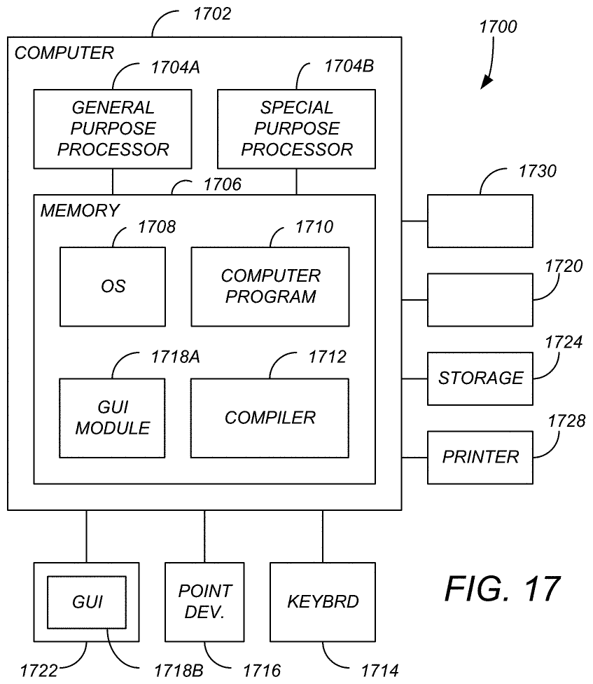

FIG. 17 illustrates an exemplary computer system 1700 that could be used to implement processing elements of the above disclosure, including a processor for laying out the circuit designs presented herein. The computer 1702 comprises a processor 1704 and a memory, such as random-access memory (RAM) 1706. The computer 1702 is operatively coupled to a display 1722, which presents images such as windows to the user on a graphical user interface 1718B. The computer 1702 may be coupled to other devices, such as a keyboard 1714, a mouse device 1716, a printer 1728, etc. Of course, those skilled in the art will recognize that any combination of the above components, or any number of different components, peripherals, and other devices, may be used with the computer 1702.

Generally, the computer 1702 operates under control of an operating system 1708 stored in the memory 1706, and interfaces with the user to accept inputs and commands and to present results through a graphical user interface (GUI) module 1718A. Although the GUI module 1718B is depicted as a separate module, the instructions performing the GUI functions can be resident or distributed in the operating system 1708, the computer program 1710, or implemented with special purpose memory and processors. The computer 1702 also implements a compiler 1712 which allows an application program 1710 written in a programming language such as COBOL, C++, FORTRAN, or other language to be translated into processor 1704 readable code. After completion, the application 1710 accesses and manipulates data stored in the memory 1706 of the computer 1702 using the relationships and logic that was generated using the compiler 1712. The computer 1702 also optionally comprises an external communication device such as a modem, satellite link, Ethernet card, or other device for communicating with other computers.

In one embodiment, instructions implementing the operating system 1708, the computer program 1710, and the compiler 1712 are tangibly embodied in a computer-readable medium, e.g., data storage device 1720, which could include one or more fixed or removable data storage devices, such as a zip drive, floppy disc drive 1724, hard drive, CD-ROM drive, tape drive, etc. Further, the operating system 1708 and the computer program 1710 are comprised of instructions which, when read and executed by the computer 1702, causes the computer 1702 to perform the operations herein described. Computer program 1710 and/or operating instructions may also be tangibly embodied in memory 1706 and/or data communications devices 1730, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### CONCLUSION

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A camouflaged sequential circuit, comprising
a plurality of serially coupled flip-flops, each of the flip-flops comprising a logic output and a logic input, each logic output communicatively coupled to an input of a serially adjacent next flip-flop;
a camouflage element, communicatively coupled between the logic output of a first flip-flop of the plurality of flip-flops and the input of a second flip-flop of the plurality of flip-flops serially adjacent the first flip-flop;
wherein the camouflage element has a physical layout mimicking a first function but performs a second function different from the first function.

2. The camouflaged sequential circuit of claim 1, wherein:
each of the plurality of serially coupled flip-flops is a multiplexed flip-flop, each of the multiplexed flip-flops further comprising a scan input, each logic output communicatively coupled to a scan input of a serially adjacent next flip-flop, at least one of the logic outputs and at least one of the logic inputs of the multiplexed flip flops are communicatively coupled to combinational logic, the plurality of serially coupled multiplexed flip-flops together forming a scan chain;
the camouflage element is communicatively coupled between the logic output of a first multiplexed flip-flop of the plurality of multiplexed flip-flops and the scan input of a second multiplexed flip-flop of the plurality of multiplexed flip-flops serially adjacent the first multiplexed flip-flop.

3. The camouflaged sequential circuit of claim 2, wherein:
the camouflage element comprises a logic cell;
one of the first function and the second function is a buffer function and the other of the first function and the second function is an inversion function.

4. The camouflaged sequential circuit of claim 2, wherein:
the camouflage element comprises the logic output of the first multiplexed flip-flop; and
one of the first function and the second function is a non-inverting function and the other of the first function and the second function is an inverting function.

5. The camouflaged sequential circuit of claim 2, wherein:
the camouflage element comprises the logic input of the second multiplexed flip-flop; and
one of the first function and the second function is a non-inverting function and the other of the first function and the second function is an inverting function.

6. The camouflaged sequential circuit of claim 2, wherein:
the camouflage element comprises the scan input of the second multiplexed flip-flop; and
one of the first function and the second function is a non-inverting function and the other of the first function and the second function is an inverting function.

7. The camouflaged sequential circuit of claim 2, wherein:
one of the first function and the second function is a delay flip-flop and the other of the first function and the second function is that of one of:
a combinational logic cell;
a buffer between the logic output of the first multiplexed flip-flop and the scan input of the second multiplexed flip-flop;
an inverting buffer between the logic output of the first multiplexed flip-flop and the scan input of the second multiplexed flip-flop; and
a multiplexer multiplexing the logic output of the first multiplexed flip-flop and an output of the combinational logic to the scan input of the second multiplexed flip-flop.

8. The camouflaged sequential circuit of claim 2, wherein:
the logic output of the first multiplexed flip-flop is communicatively coupled to combinational logic;
the logic input of the second multiplexed flip-flop is communicatively coupled to the combinational logic;
one of the first function and the second function is a flip-flop and the other of the first function and the second function is that of one or more of:
a buffer between the logic output of the first multiplexed flip-flop and the logic input of the second multiplexed flip-flop;
an inverting buffer between the logic output of the first multiplexed flip-flop and the logic input of the second multiplexed flip-flop; and
a sequential element coupled between the logic output of the first multiplexed flip-flop and the scan input of the second multiplexed flip-flop.

9. The camouflaged sequential circuit of claim 2, wherein:
the first multiplexed flip-flop and the second multiplexed flip-flop are members of a first scan chain;
the camouflage element comprises a logic gate; and
the first function is a logical function of the logic output of the first multiplexed flip-flop and the logic output of a multiplexed flip-flop of a second scan chain, and the second function is a logical function of only the logical output of the first multiplexed flip-flop.

10. The camouflaged sequential circuit of claim 2, wherein:
the camouflage element comprises a logic gate; and
the first function is a logical function of the logic output of the first multiplexed flip-flop and a logic output of another multiplexed flip-flop in the scan chain, and the second function is a logical function of only the logical output of the first multiplexed flip-flop.

11. The camouflaged sequential circuit of claim 1, wherein:
the plurality of serially coupled flip-flops together comprise a shift register;
one of the first function and the second function is that of a delay flip-flop and the other of the first function and the second function is that of one of:
a combinational logic cell;
a buffer between the logic output of the first flip-flop and the input of the second flip-flop; and
an inverting buffer between the logic output of the first flip-flop and the input of the second flip-flop; and
a multiplexer multiplexing the logic output of the first flip-flop and the input of the second flip-flop.

12. The camouflaged sequential circuit of claim 1, wherein:
the first flip-flop and the second flip-flop are members of a shift register;
the camouflage element comprises a logic gate; and
the first function is a logical function of the logic output of the first flip-flop and a logic output of another flip-flop in the shift register, and the second function is a logical function of only the logical output of the first flip-flop.

13. A method of producing a camouflaged sequential circuit, comprising:
interconnecting a plurality of serially coupled flip-flops, each of the flip-flops comprising a logic output and a logic input, each logic output communicatively coupled to an input of a serially adjacent next flip-flop;
inserting a camouflage element, communicatively coupled between the logic output of a first flip-flop of the plurality of flip-flops and the input of a second flip-flop of the plurality of flip-flops serially adjacent the first flip-flop;
wherein the camouflage element has a physical layout mimicking a first function but performs a second function different from the first function.

14. The method of claim 13, wherein:
each of the plurality of serially coupled flip-flops are multiplexed flip-flops, each of the multiplexed flip-flops further comprising a scan input, each logic output communicatively coupled to a scan input of a serially adjacent next flip-flop, at least one of the logic outputs and at least one of the logic inputs of the multiplexed flip flops are communicatively coupled to combinational logic, the plurality of serially coupled multiplexed flip-flops together forming a scan chain;
the camouflage element is communicatively coupled between the logic output of a first multiplexed flip-flop of the plurality of multiplexed flip-flops and the scan input of a second multiplexed flip-flop of the plurality of multiplexed flip-flops serially adjacent the first multiplexed flip-flop.

15. The camouflaged sequential circuit of claim 14, wherein:
the camouflage element comprises a logic cell;
one of the first function and the second function is a buffer function and the other of the first function and the second function is an inversion function.

16. The camouflaged sequential circuit of claim 14, wherein:
the camouflage element comprises the logic output of the first multiplexed flip-flop; and
one of the first function and the second function is a non-inverting function and the other of the first function and the second function is an inverting function.

17. The camouflaged sequential circuit of claim 14, wherein:
the camouflage element comprises the logic input of the second multiplexed flip-flop; and
one of the first function and the second function is a non-inverting function and the other of the first function and the second function is an inverting function.

18. The camouflaged sequential circuit of claim 14, wherein:
the camouflage element comprises the scan input of the second multiplexed flip-flop; and
one of the first function and the second function is a non-inverting function and the other of the first function and the second function is an inverting function.

19. The camouflaged sequential circuit of claim 14, wherein:
one of the first function and the second function is a delay flip-flop and the other of the first function and the second function is that of one of:
a combinational logic cell;
a buffer between the logic output of the first multiplexed flip-flop and the scan input of the second multiplexed flip-flop;
an inverting buffer between the logic output of the first multiplexed flip-flop and the scan input of the second multiplexed flip-flop; and
a multiplexer multiplexing the logic output of the first multiplexed flip-flop and an output of the combinational logic to the scan input of the second multiplexed flip-flop.

20. The camouflaged sequential circuit of claim 14, wherein:
the logic output of the first multiplexed flip-flop is communicatively coupled to combinational logic;
the logic input of the second multiplexed flip-flop is communicatively coupled to the combinational logic;
one of the first function and the second function is a flip-flop and the other of the first function and the other of the first function and the second function is that of one or more of:
a buffer between the logic output of the first multiplexed flip-flop and the logic input of the second multiplexed flip-flop;
an inverting buffer between the logic output of the first multiplexed flip-flop and the logic input of the second multiplexed flip-flop; and
a sequential element coupled between the logic output of the first multiplexed flip-flop and the scan input of the second multiplexed flip-flop.

21. The camouflaged sequential circuit of claim 14, wherein:
the first multiplexed flip-flop and the second multiplexed flip-flop are members of a first scan chain;
the camouflage element comprises a logic gate; and
the first function is a logical function of the logic output of the first multiplexed flip-flop and the logic output of a multiplexed flip-flop of a second scan chain, and the second function is a logical function of only the logical output of the first multiplexed flip-flop.

22. The camouflaged sequential circuit of claim 14, wherein:
the camouflage element comprises a logic gate; and
the first function is a logical function of the logic output of the first multiplexed flip-flop and a logic output of another multiplexed flip-flop in the scan chain, and the second function is a logical function of only the logical output of the first multiplexed flip-flop.

23. The camouflaged sequential circuit of claim 13, wherein:
the plurality of serially coupled flip-flops together comprise a shift register;
one of the first function and the second function is that of a delay flip-flop and the other of the first function and the second function is that of one of:
a combinational logic cell;
a buffer between the logic output of the first flip-flop and the input of the second flip-flop; and
an inverting buffer between the logic output of the first flip-flop and the input of the second flip-flop; and
a multiplexer multiplexing the logic output of the first flip-flop the input of the second flip-flop.

24. The camouflaged sequential circuit of claim 13, wherein:
the first flip-flop and the second flip-flop are members of a shift register,
the camouflage element comprises a logic gate; and
the first function is a logical function of the logic output of the first flip-flop and a logic output of another flip-flop in the shift register, and the second function is a logical function of only the logical output of the first flip-flop.

25. A camouflaged sequential circuit produced by performing steps comprising the steps of:
interconnecting a plurality of serially coupled flip-flops, each of the flip-flops comprising a logic output and a logic input, each logic output communicatively coupled to an input of a serially adjacent next flip-flop;
inserting a camouflage element, communicatively coupled between the logic output of a first flip-flop of the plurality of flip-flops and the input of a second flip-flop of the plurality of flip-flops serially adjacent the first flip-flop;
wherein:
the camouflage element has a physical layout mimicking a first function but performs a second function different from the first function.
each of the plurality of serially coupled flip-flops are multiplexed flip-flops, each of the multiplexed flip-flops further comprising a scan input, each logic output communicatively coupled to a scan input of a serially adjacent next flip-flop, at least one of the logic outputs and at least one of the logic inputs of the multiplexed flip flops are communicatively coupled to combinational logic, the plurality of serially coupled multiplexed flip-flops together forming a scan chain;
the camouflage element is communicatively coupled between the logic output of a first multiplexed flip-flop of the plurality of multiplexed flip-flops and the scan input of a second multiplexed flip-flop of the plurality of multiplexed flip-flops serially adjacent the first multiplexed flip-flop.
